(19) United States
(12) Patent Application Publication
(10) Pub. No.: US 2022/0016585 A1
(43) Pub. Date: Jan. 20, 2022

(54) DEVICE FOR GENERATING VORTICES IN CHANNELS OR PIPES

(71) Applicant: UNIVERSIDAD DE SEVILLA, Sevilla (ES)

(72) Inventors: Javier DAVILA MARTIN, Sevilla (ES); Alonso FERNANDEZ MORALES, Sevilla (ES)

(21) Appl. No.: 17/312,297

(22) PCT Filed: Dec. 12, 2019
(86) PCT No.: PCT/ES2019/070842

§ 371 Date: Jun. 9, 2021

(30) Foreign Application Priority Data
Dec. 14, 2018 (ES) P201831212

(51) Int. Cl. B01F 5/06; F15D 1/06; B01F 3/04; B01F 7/04

(52) U.S. Cl. CPC B01F 5/061; F15D 1/06; B01F 2005/0622; B01F 7/04; B01F 3/04

(57) ABSTRACT

A vortex generator device in channels or ducts that makes it possible to take advantage of the wingtip vortex that is formed in the aerodynamic profiles as a consequence of having a finite wingspan. These aerodynamic profiles have one or two marginal edges from which the wingtip vortex emerges, causing the appearance of an oscillatory movement that subjects the particles that travel with the current to an ascending-descending cycle, and has the fundamental advantage that transverse speeds are produced to the main current, with hardly any pressure drops.

### OBJECTIVES OF THE INVENTION

The present invention refers to a vortex generator device in channels or conduits that allows stable vortices to be generated along channels or conduits through the use of streamlined bodies, so that the vortex produced has its axis of rotation parallel to the direction of the flow. The device object of the present invention is applicable in fields where it is important to achieve efficient agitation of fluids with minimum energy consumption. In particular, it is applicable in biological culture growth processes in which the energy consumption necessary for agitation of the crop is one of the main operating costs, at the same time that its productivity is limited by the mixing capacity.

### BACKGROUND OF THE INVENTION

Different in-line mixing systems are known in the state of the art, such as, for example, so-called static mixers, which incorporate different designs of solid elements, usually inside a duct. These elements produce a good mixing of the flow due to a strong increase in the turbulent intensity, that is, the level of speed fluctuations with respect to the average flow speed. However, existing static mixers produce a high pressure drop (backwater pressure drop) in relation to the kinetic energy of the flow. Examples of static mixers are listed in the following patent documents: EP2433706, WO2010039162, CN202893218 and JPS5919524.

Some static mixers are based on thin plates, but their behavior is very different from that of an aerodynamic profile, since either the angle of attack is very high (which causes the detachment of their boundary layer) or they are anchored by the leading edge or the trailing edge to any of the walls of the duct, such as those described in patent applications with publication number US2006158961 or WO0062915.

Other mixing systems are based on the generation of turbulent fluctuations through shear zones, such as jets or mixing layers, and can be more efficient than static mixers. Turbulent fluctuations are also generated in the shear zones that allow the mixing of compounds in solution or of different fluids, as occurs in the device described in patent application US2010163114.

In addition to the designs mentioned, there are other mixers in which a rotating current is generated without moving parts that could be called tangential mixers. Examples of this technique appear in patents ZA9802249, JP2012006013 and US2016250606. In these cases, in addition to the turning current, an increase in the intensity of the turbulence is also usually sought. Another technique also based on the generation of rotation in which a toroidal vortex is created to mix a region of fluid is described in patent U.S. Pat. No. 5,823,676.

On the other hand, there are also other mechanical mixers with moving parts, such as propellers with axes parallel to the axis of the duct, which, although they can be much more efficient than those mentioned above, are usually not suitable for use with liquids laden with particles or when biological species are cultivated and have high maintenance costs. These mixers can also produce a longitudinal vortex (with its axis parallel to the direction of the duct), with different levels of turbulence depending on whether, in addition to producing the rotation of the current, it is also desired to achieve a transversal mixing of the moving fluids.

The efficiency of these systems can be characterized by the level of agitation and mixing achieved, divided by the dimensionless coefficient of pressure drop. Depending on the objective sought, the level of agitation or mixing can be characterized in different ways, such as:

a) The reduction of the dispersion of the concentration obtained with respect to the mean.

b) The dispersion of the distance of different particles with respect to a reference position, such as the central axis of the duct or the initial position of the particles.

On the other hand, the head loss coefficient is defined as the backwater pressure loss, divided by the kinetic energy of the mean flow per unit volume. Most of the systems currently used for in-line mixing produce a very high pressure drop, as the resulting flow is very turbulent with many recirculation zones. Turbulent fluctuations in speed are very effective for mixing fluids, but at the same time they also have significant losses in momentum due to the so-called Reynolds apparent stress tensor. On the other hand, if the intensity of the turbulence is very low, the velocity fluctuations are much less effective for mass transport, so in this case it is essential that the trajectories of the fluid particles are not parallel to the axis of the duct or channel. One method to achieve this is to generate waves on the surface of the channels, so that circular or elliptical paths appear that produce an effective agitation of the flow in the area close to the free surface.

In addition to the aforementioned drawbacks of the other stirring and mixing systems, in some facilities it is essential to maintain very demanding cleaning conditions, as is often the case in biological culture. In these cases, agitators with essentially flat blades or blades are usually used. Within this group of agitation systems, propeller agitators (axial impellers) and the different types of paddle wheels could be included.

The vortex generating device in channels or conduits of the present invention solves all the above drawbacks.

### DESCRIPTION OF THE INVENTION

The present invention refers to a vortex generator device in channels or conduits that favors the agitation of an essentially parallel current that flows through the conduit or channel comprising side walls and a bottom or hearth, generating wingtip vortices without a substantial increase in the intensity of turbulence.

The vortex generating device in channels or conduits of the present invention is described in the claims, which are included herein by reference. Thus configured, the vortex generating device in channels or ducts comprises at least one fuselage body in the form of a fin or aerodynamic profile, anchored to one of the side walls or to the bottom of the channel or duct by the edge opposite the marginal edge of the fin or aerodynamic profile, or fixed to a first solid structure, which allows the controlled incorporation of intense wingtip vortices into the main flow of the duct or channel.

Preferably, the at least one vane or airfoil is anchored to one of the side walls or the bottom of the channel or duct by the edge opposite the marginal edge of the vane or airfoil, or anchored to the first solid structure to the channel or duct, by means of fixing.

The foundation of the vortex generator device in channels or ducts is the use of the wingtip vortex that forms on the marginal edges of the aerodynamic profiles as a consequence of the appearance of areas of higher and lower relative pressure due to being aerodynamic bodies of finite wingspan. In said aerodynamic bodies, the leading edge is defined as the edge on which the main current falls and as the trailing edge the one that is downstream in the direction of the main current. Aerodynamic profiles consist of one or two marginal edges, which are the side edges in the main direction. The aerodynamic profile comprises a single marginal edge if it is directly adhered to one of the walls of the duct or channel or if one of its lateral edges is out of current.

Thus configured, the vortex generating device in channels or ducts causes the wingtip vortex to detach from the marginal edge of a fin or airfoil and cause the appearance of an oscillatory movement that subjects the particles that travel with the current to an up-down cycle. For this reason, the present invention has the fundamental advantage that transverse speeds to the main current are produced with hardly any head losses, instead of starting from a strong increase in turbulent intensity by any other method, as known in the art. state of the art, which is key so that energy efficiency can be maximized.

The vortex generating device in channels or ducts of the present invention promotes the wingtip vortex, for which the angle that the fin or airfoil forms with the incident current must be small. In aerodynamics, the angle of attack of a longitudinal section of a fuselage body is defined as the angle that the incident current forms with the reference line of the longitudinal section of the fuselage body, which is in turn the line that joins the leading edge with the trailing edge for the same longitudinal section of the fuselage body and defining the so-called chord of the longitudinal section of the fuselage body. For a fin or airfoil to behave as a fuselage body for at least one part of the fuselage body, the angle of attack must be reduced. For this reason, in the wingtip vortex generator device the minimum angle of attack of the fin or aerodynamic profile is between −20° and 20°, since otherwise its boundary layer would be completely detached and, as a consequence, the pressure differences would be much smaller and hydraulic losses would be much higher, contrary to the objective sought.

An aerodynamic profile comprises a first lateral face defined between the leading edge and the trailing edge and a second lateral face defined between the leading edge and the trailing edge, so that, as a consequence of the operation of the aerodynamic profile as a fuselage body there is a notable difference in pressure between the two lateral faces. The first lateral face or lateral face on which the overpressures occur is called the high-pressure face and the second lateral face or face on which a depression occurs with respect to the pressure of the incident current is called the low-pressure face. This means that an aerodynamic profile of finite wingspan produces wingtip vortices, since a favorable pressure gradient is generated from the high-pressure face towards the low-pressure face, which in turn generates a current around the marginal edge or tip called edge current.

If the wingspan of the profile is much greater than the maximum chord, the pressures on the high-pressure and low-pressure faces are very uniform and the effect of the wingtip vortex on the lift force of said profile is reduced. Since in the present invention it is intended to intensify the wingtip vortex, fins or aerodynamic profiles will be used in which the ratio between the sum of the surface of the high-pressure face and the low-pressure face of the fin or aerodynamic profile over the square of its maximum chord is less than 8. Therefore, in these profiles the span is of the same order of magnitude as the maximum chord.

In the field of hydraulic engineering, the hydraulic diameter of a hydraulic duct or channel (DH) is defined as four times the area of its cross-section (A) divided by the perimeter wetted by the fluid (p), which is the length of the contour of the section that is in contact with the fluid flowing through the duct or channel:

DH=4A/p

For circular ducts, DH matches the inside diameter of the duct. In the case of square section ducts, DH coincides with the height of the duct. When a channel or conduit has a section with a base, b, much greater than its height h, (b>>h) the hydraulic diameter is of the order of the height of the conduit, h, that is, the smallest of dimensions that define the cross section.

The losses of mechanical energy per unit volume in a channel or duct with a cross section of area A, which occur as a consequence of a narrowing of the section produced by the existence of a submerged device, where the area of the projection of the device on a plane perpendicular to the direction of the axis of the duct or channel is Ap, they can be determined as:

$$Δ H \approx - \frac{1}{2} ρ {v}^{2} \frac{{A}_{p}^{2}}{{A}^{2}}$$

Therefore, for the losses produced by the vortex generating device to be small in relation to the inertia of the fluid, it is necessary that Ap be less than 0.5 times the section of the duct, A. Thus, the head loss coefficient, k, which is defined as:

$$K = Δ H \text{/} ( \frac{1}{2} ρ {v}^{2} ) ,$$

it will be much less than unity, which means that the losses produced by the device are negligible, thus maximizing the efficiency of the process.

On the other hand, for the wingtip vortex to be incorporated into the main flow of the duct or channel and therefore to form in an area where energy dissipation is not high, it is advisable that the marginal edge of a fin or airfoil is not present within or near the boundary layers of the walls or bottom of the duct or channel. In most applications of industrial interest the flow is turbulent and the thickness of the boundary layer can be estimated as 5000 times the ratio of the kinematic viscosity to the mean flow velocity. Therefore, for the wingtip vortex not to dissipate rapidly, the minimum distance from the marginal edge of a fin or airfoil to the walls or bottom of the duct or channel must be greater than the result of multiplying 10000 by the kinematic viscosity of the fluid and divide by average is velocity in the channel or conduit.

Furthermore, as an optional aspect of the invention, the marginal edge of a fin or airfoil is at a minimum distance to the nearest solid wall greater than the hydraulic diameter of the duct or channel divided by 20, that is, the distance from the marginal edge from the fin or aerodynamic profile to the first solid structure or to a second solid structure is greater than the hydraulic diameter of the channel or duct divided by 20. In the event that the distance to the wall is less than that DH/20 ratio, the wall would produce a strong interaction with the vortex, which would not efficiently achieve the desired objective.

On the other hand, in order to obtain greater pressure differences between the upper and lower surface of a fin or aerodynamic profile, it is convenient that the angle of attack that is defined for the different longitudinal sections increases from its root (central plane in the case of profiles with two marginal edges) towards one of its marginal edges, which is the area where the wingtip vortices form.

For the same reason, to obtain greater pressure differences between the top and bottom and at the same time avoid the detachment of the boundary layer, it is convenient that there is a certain curvature in the longitudinal section of a fin or aerodynamic profile, so it is advisable that the wingtip vortex generating device has a fin or aerodynamic profile with a longitudinal section in which the maximum height of the profile, called maximum sag, is between 25% and 75% of its chord. These values exclude aerodynamic profiles where the maximum camber is very close to the leading or trailing edge, which are more prone to boundary layer shedding at the profile edges.

In another particular embodiment of the invention, the at least one fin or aerodynamic profile of the vortex generating device in channels or ducts has the marginal edge substantially thicker than the average thickness of a fin or aerodynamic profile and is rounded to facilitate the formation of wingtip vortices. In the aeronautical industry, to reduce the formation of wingtip vortices, profiles perpendicular to the blade are placed, which are called wingtip devices (“winglets”). In contrast, for the device of the present invention, the marginal edge is thickened to facilitate wingtip vortex formation. For this reason, in a fin or airfoil, the mean value of the radius of curvature of the marginal edge is greater than the average thickness of said fin or airfoil.

In summary the invention relates to the device claims included in this application, which are included herein by reference.

The wingtip vortex generation device described above is applicable for agitation in various industrial equipment, such as tubular chemical reactors, tubular reagent mixing systems, tubular biological reactors and biological culture tanks open to the atmosphere. Their ability to generate transversal velocities from a parallel main current makes them also applicable for the resuspension of solid particles found on the bottom of canals, rivers, ports, docks and estuaries. Therefore, the invention also relates to a method of stirring in channels and ducts by generating vortices by means of the device for generating vortices in channels or ducts described above.

### BRIEF DESCRIPTION OF THE DRAWINGS

FIG. 1 shows a perspective view of a rectangular section channel or conduit with the vortex generating device in channels or conduits of the present invention anchored to one of the walls of a conduit. The leading edge, trailing edge and marginal edge of the fin are shown, as well as the generated wingtip vortex.

FIG. 2 shows a longitudinal section of the vortex generating device in channels or ducts of the present invention where the angle of attack is indicated in relation to the direction of the incident current, the chord and the maximum camber for that longitudinal section of said device.

FIG. 3 shows a longitudinal section of the vortex generating device in channels or conduits of the present invention where the typical pressure distribution on the high and low pressure faces of said device is shown.

FIG. 4 shows a cross section of the vortex generating device in channels or conduits of the present invention where the pressure distribution on the high and low pressure faces of said device and the edge current are shown.

FIG. 5 shows a perspective view of a channel or duct of rectangular section with the device of the present invention anchored to one of the walls, where the cross section of the channel or duct and the projection of the device in the direction of the main current on a plane perpendicular to the axis of the duct is shown.

### PREFERRED EMBODIMENT OF THE INVENTION

The references used in the figures of the vortex generator device in channels or ducts of the present invention, which will be explained in detail below, are the following:

1: flow with a direction essentially parallel to the walls of the duct or channel.

2: channel or duct wall.

3: bottom of the canal or duct.

4: wingtip vortex generated by the profile.

5: fin or aerodynamic profile.

6: leading edge.

7: trailing edge.

8: marginal edge.

9: angle of attack.

10: chord.

11: maximum sag.

12: high-pressure face.

13: low-pressure face.

14: edge current.

15: b.

16: h.

17: Ap.

The behavior of a fuselage profile immersed in a fluid current is very well described by its applications in aeronautical engineering. The most important aerodynamic characteristics of a profile are its coefficient of lift, CL, and its coefficient of aerodynamic drag, CD, defined as

$$\begin{matrix}{C}_{L} = \frac{L}{\frac{1}{2} ρ {v}^{2} S} \\ y & ( 1 ) \\ {C}_{D} = \frac{D}{\frac{1}{2} ρ {v}^{2} S} , & ( 2 )\end{matrix}$$

where L and D are, respectively, the lift forces and aerodynamic drag on the profile and S is the wing surface.

These two coefficients vary as a function of the Reynolds number, although it is generally sufficient to consider the asymptotic values for very high Reynolds numbers in fully developed turbulence. In addition, the coefficients also vary depending on the angle of attack of the fin or aerodynamic profile. When the boundary layer on the profile is adhered and the wake that emerges from the trailing edge is very narrow, the coefficient of aerodynamic resistance, CD, is much less than unity, since in this case the losses are produced by friction with profile walls, a generally negligible effect at high Reynolds numbers. In the same situation, the lift coefficient CL, is usually of unit order, presenting an increasing dependence with the angle of attack, until for a certain critical angle the so-called lift crisis occurs, in which the boundary layer on the low-pressure face detaches before reaching the trailing edge. From that angle, the lift of the aerodynamic profile decreases sharply as the angle of attack increases as a result of the detachment of the boundary layer and a lower pressure difference between the high-pressure face (overpressure face) and the low-pressure face (depression). To achieve higher lift values, profiles with a certain thickness and curvature can be used, which allows the boundary layer not to detach at higher angles of attack.

As explained above, to increase the intensity of the wingtip vortex that occurs on a profile, it is convenient that the pressure difference between the high-pressure and the low-pressure face be high along the entire chord of the fin or aerodynamic profile. As a consequence of the aforementioned, the aerodynamic profile should work with high angles of attack, but without reaching the critical value in which the lift crisis occurs due to the detachment of the boundary layer.

The type of vortex that emerges from the marginal edge of the fin or airfoil can be modeled as a cylindrical vortex, which in the case of a channel or conduit stream would have an axis essentially parallel to the axis of the same channel or conduit.

In specialized literature, cylindrical vortex models such as the Rankine vortex or the Burgers vortex are often used (Dávila J. & Hunt J. C. R. 2001, Settling of small particles near vortices and in turbulence. J. Fluid Mech. 440, 117-145). These models describe a dependence of the azimuth velocity (around the vortex axis) as a function of the distance from the vortex axis.

The most important parameters of cylindrical vortices are their viscous radius, Rv, and the circulation of the vortex. The first of these parameters determines the distance to the vortex axis at which the azimuth velocity is maximum. When the Reynolds number is high, the viscous radius is very small (typically on the order of one millimeter) and the vortex circulation is approximately constant. From the point of view of agitation, it is important that the circulation of the vortex is high, which is closely related to high values of the lift coefficient of the fin or aerodynamic profile and the angle of attack.

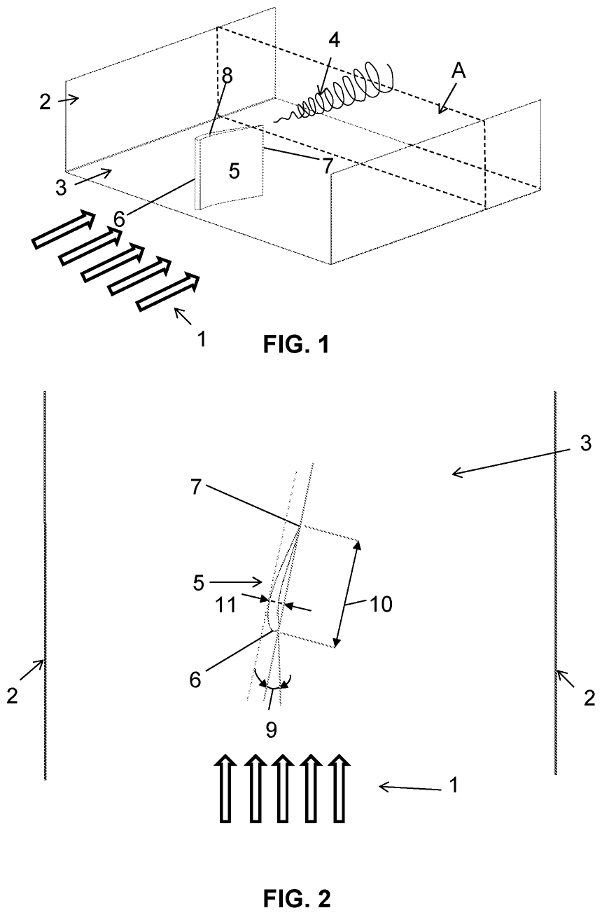

The technical problem solved by the present invention is to favor the agitation of an essentially parallel stream (1) that flows through a conduit or a channel formed by side walls (2) and a bottom or hearth (3) (FIG. 1). To do this, the generation of wingtip vortices (4) is used through the use of fins or aerodynamic profiles, without a substantial increase in the intensity of the turbulence.

For this, the vortex generator device in channels or ducts of the present invention comprises at least one fin or aerodynamic profile (5), anchored to one of the side walls (2) or to the bottom (3) of the channel or duct by means of the edge opposite the marginal edge (8) of the fin or aerodynamic profile (5), or anchored to a first solid structure, by means of fixing means, so that a controlled incorporation of intense wingtip vortices (4) to the main flow (1) of the duct or channel is produced.

The foundation of the device is the use of the wingtip vortex (4) that is formed in the aerodynamic profiles (5) as a consequence of having a finite wingspan. In said profiles, the leading edge (6) is defined as the edge on which the main current (1) falls and the trailing edge (7) is the one that is downstream in the direction of the current (1) (FIG. 1). These profiles consist of one or two marginal edges (8), which are the lateral edges in the direction of the main stream (1). The profiles will have a single marginal edge when it is attached directly to one of the solid walls of the conduit or channel, or one of its sides protrudes through the surface in a channel or conduit.

The wingtip vortex (4) detaches from the marginal edge (8) of the fin or aerodynamic profile (5) and causes the appearance of an oscillatory movement that subjects the particles that travel with the current to an ascending-descending cycle. For this reason, the present invention has the fundamental advantage that transverse speeds to the main current are produced with little introduction of head losses, instead of starting from a strong increase in turbulent intensity through any other procedure, which is key to that energy efficiency can be maximized.

The device designed, therefore, tries to promote the wingtip vortex (4), for which the angle of attack of the fin or aerodynamic profile must be small, since otherwise the boundary layer would be detached and, consequently, the lift force would be much lower and the hydraulic losses would be much higher, against the objective that is being sought. Therefore, the angle of attack must be between −20° and 20°. As shown in FIG. 2, the angle of attack of a longitudinal section (9) is that formed by the incident current with the reference line of a fuselage body, which is the line that joins the leading edge of the at least one fin or aerodynamic profile with the trailing edge and that defines the so-called chord (10) of the fin or aerodynamic profile (5) in said longitudinal section (FIG. 2).

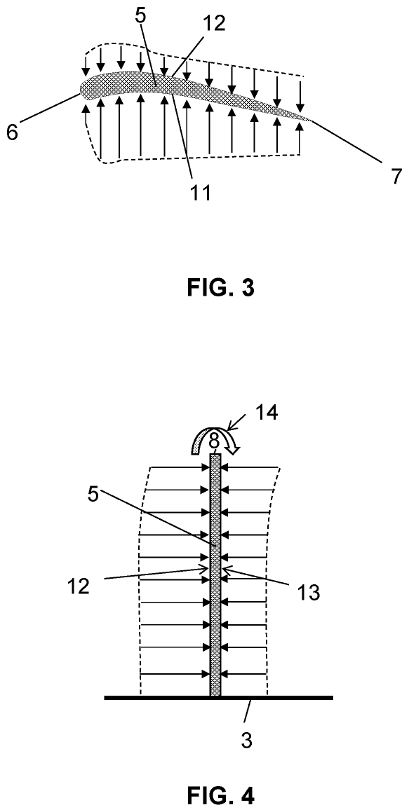

As a consequence of the operation of the profile as a fuselage body, there is a notable difference in pressure between the two faces of the fin or aerodynamic profile (5) (FIG. 3). The face on which the overpressures occur is called high-pressure face (12) and the face on which a depression occurs with respect to the pressure of the incident current is called low-pressure face (13). This allows us to explain why a finite wingspan aerodynamic profile (5) produces wingtip vortices, since from the high-pressure face (12) towards the low-pressure face (13) a favorable pressure gradient is generated which in turn generates a current around of the marginal edge (8) called edge current (14), as indicated in FIG. 4.

If the wingspan of the profile is much greater than the maximum chord, the pressures in the high-pressure face (12) and the low-pressure face (13) are very uniform and the effect of the wingtip vortex (4) on the lift force of said profile is reduced. Since the present invention intends to intensify the wingtip vortex (4), fins or aerodynamic profiles will be used in which the ratio of the sum of the surface of the high-pressure face (12) and the low-pressure face (13) of the fin or aerodynamic profile over the square of its maximum chord (10) is less than 8. Therefore, in these profiles the wingspan is of the same order of magnitude as the maximum chord.

In the field of hydraulic engineering, the hydraulic diameter of a hydraulic duct or channel (DH) is defined as four times the area of its cross-section (A) divided by the perimeter wetted by the fluid (p), which is the length of the contour of the section that is in contact with the fluid flowing through the duct or channel:

D_{H}=4A/p (3)

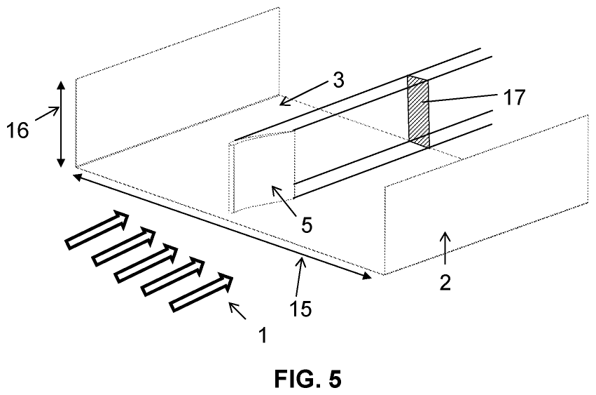

For circular ducts, DH matches the inside diameter of the duct. In the case of square section ducts, it matches the height of the duct. When a channel or conduit has a section with a base, b (13), much greater than its height h (14), (b>>h) the hydraulic diameter is of the order of the height of the conduit, h, that is, of the smallest of the dimensions that define the cross section (FIG. 5).

The losses of mechanical energy per unit volume in a channel or duct with a cross section of area A, which occur as a consequence of a narrowing of the section produced by the existence of a submerged device whose area Ap, of the projection of the device (15) on a plane perpendicular to the direction of the axis of the duct or channel (FIG. 5), can be determined as

$$Δ H \approx - \frac{1}{2} ρ {v}^{2} \frac{{A}_{p}^{2}}{{A}^{2}} \qquad ( 4 )$$

Therefore, for the losses produced by the vortex generating device to be small in relation to the inertia of the fluid, it is necessary that Ap be less than 0.5 times the section of the duct, A. Thus, the head loss coefficient, k, which is defined as

$$K = Δ H \text{/} ( \frac{1}{2} ρ {v}^{2} ) \qquad ( 5 )$$

it will be much less than unity, which means that the losses produced by the device are negligible, thus maximizing the efficiency of the process.

### EXAMPLE OF PRACTICAL EMBODIMENT OF THE INVENTION

A practical embodiment of the invention is shown in the attached figures, where the device requires the supply of a flow of gas or liquid to be stirred. This flow rate must be high enough so that the Reynolds number associated with the flow around the profiles that form the vortex generating device is high. On the other hand, the number of fins or profiles and/or their surface will be increased if necessary to achieve the levels of agitation required for each specific application. Likewise, the angle of attack, the chord or the curvature of the profiles will be increased if more agitation is required.

The flow rate of the fluid to be stirred must be as homogeneous as possible upstream of the aerodynamic profiles to avoid detachment of the boundary layer near the leading edge.

The materials in which the vortex generating device can be manufactured are multiple (metal, plastic, composites, etc.), the choice of material mainly depending on the specific application in which the device is to be used.

FIGS. 1 and 2 show the diagram of a prototype installed in a hydrodynamic channel or wall duct (2) and base (3), in which an aerodynamic profile with parallel sides has been fixed to the bottom of said channel or duct (4) by the edge opposite its marginal edge (8). In this prototype we have worked with water velocities of the incident current of between 0.3 and 0.5 m/s. The width of the profile was 15 cm, the length of its marginal edge also 15 cm and its average thickness 4 mm. Tests have been carried out in a range of attack angles (9) of the aerodynamic profile (5) of between 0° and 20°. The marginal edge of the profile was at a distance from the nearest wall equivalent to 0.5 times the hydraulic diameter of the conduit, which in this case was 30 cm.

For the hydrodynamic channel or duct, the thickness of the boundary layers of the walls can be estimated at 5000 times the kinematic viscosity of the fluid (water) divided by average velocity. In this case, the thickness is therefore of the order of one centimeter, so that the marginal edge of the fin does not interact with these areas of high energy dissipation.

As shown in FIG. 5, to ensure a minimum pressure drop in this prototype, the projection of the section of the profile in the direction of the current had an area between 0 and 20 cm2.

1. A vortex generator device in channels or ducts comprising:
at least one channel or conduit through which a fluid circulates comprising a kinematic viscosity and an average speed of the fluid in the channel or conduit, where the channel or conduit comprises at least two walls and a bottom,
at least one fin or aerodynamic profile where the fluid impacts, which in turn comprises a face on which overpressures are produced due to the incidence of the fluid, or high-pressure face, and a face on which there are depressions with respect to the overpressures in the high-pressure face, or low-pressure face, and a maximum chord,
wherein the at least one fin or aerodynamic profile is fixed to one of the at least two walls or to the bottom of the channel or duct by means of an edge opposite a marginal edge of the fin or aerodynamic profile, or is fixed to a first solid structure, the solid structure comprising:
an angle of attack of said fin or aerodynamic profile between −20° and 20°;
a ratio of a sum of the surface of the high-pressure face and the low-pressure face of the fin or aerodynamic profile over the square of its maximum chord is less than 8, and
a distance from the marginal edge of the fin or aerodynamic profile to one of the at least two walls or to the bottom of the channel or duct, whichever is the minimum, is greater than a result of multiplying 10000 by a kinematic viscosity of the fluid and divided by an average speed of the fluid in the channel or conduit.

2. The vortex generator device in channels or ducts according to claim 1, wherein the channel or duct comprises a hydraulic diameter and also the distance from the marginal edge of the fin or aerodynamic profile to the first structure solid or a second solid structure is greater than the hydraulic diameter of the channel or conduit divided by 20.

3. The vortex generator device in channels or ducts according to claim 1, wherein the channel or duct comprises an axis and a cross section, where the ratio between an area of the projection of the at least one fin or profile aerodynamic on a plane perpendicular to the direction of the axis of the channel or conduit and the cross-sectional area of the channel or conduit is less than 0.5.

4. The vortex generator device in channels or ducts according to claim 1, wherein the at least one fin or airfoil comprises a root where the at least one fin or airfoil comprises an angle of attack increasing from its root towards the marginal edge.

5. The vortex generator device in channels or ducts according to claim 1, wherein the at least one fin or aerodynamic profile has, in one of its longitudinal sections, a maximum camber between the 25% and 75% of its maximum chord.

6. The vortex generator device in channels or ducts according to claim 1, wherein the marginal edge of the at least one fin or aerodynamic profile comprises a radius of curvature and the at least one fin or aerodynamic profile comprises an average thickness, where an average value of the radius of curvature of the marginal edge is greater than the average thickness of said fin or aerodynamic profile.

7. A method of agitation in channels and ducts comprising generating vortices in channels or ducts by means of the vortex generating device of claim 1.
